(19) United States
(12) Patent Application Publication
(10) Pub. No.: US 2018/0056588 A1
(43) Pub. Date: Mar. 1, 2018

(54) APPARATUS FOR ADDITIVE MANUFACTURING OF AT LEAST ONE THREE-DIMENSIONAL OBJECT

(71) Applicant: CL SCHUTZRECHTSVERWALTUNGS GMBH, Lichtenfels (DE)

(72) Inventors: Frank Herzog, Lichtenfels (DE); Florian Bechmann, Lichtenfels (DE); Fabian Zeulner, Lichtenfels (DE); Christian Diller, Lichtenfels (DE); Tim Döhler, Grossheirath (DE); Jens Stammberger, Rodental (DE)

(73) Assignee: CL SCHUTZRECHTSVERWALTUNGS GMBH, Lichtenfels (DE)

(21) Appl. No.: 15/684,856

(22) Filed: Aug. 23, 2017

(30) Foreign Application Priority Data
Aug. 23, 2016 (DE) 102016115575.6

(51) Int. Cl. B29C 64/268; B29C 64/20; B29C 64/386; B29C 64/393

(52) U.S. Cl. CPC B29C 64/268; B29C 64/20; B29C 64/153; B29C 64/393; B29C 64/386

(57) ABSTRACT

An apparatus (1) for additive manufacturing of at least one three-dimensional object (2) by successive selective solidification of individual construction material layers (3) of a particulate construction material (4) that can be solidified by means of an energy beam (6) generated by a beam generation device (5), comprising at least one beam generation device (5) for the generation of an energy beam (6) and at least one coating device (9) for forming a construction material layer to be solidified in a construction plane (3), characterized by at least one fluidization device (10) provided for at least sectional fluidization of the construction material (4) that can be applied as a construction material layer to be selectively solidified and/or the construction material (4) applied as a construction material layer to be selectively solidified.

The invention relates to an apparatus for additive manufacturing of at least one three-dimensional object by successive selective solidification of individual construction material layers of particulate construction material which can be solidified by means of an energy beam generated by a beam generation device. The apparatus comprises, among other things, at least one beam generation device for the generation of an energy beam and at least one coating device for forming a construction material layer to be solidified in a construction plane.

Such apparatuses are actually known for additive manufacturing of three-dimensional objects. By means of respective apparatuses, three-dimensional objects to be manufactured are successively constructed additively by selectively solidifying construction material layers of particulate construction material which can be solidified, applied in a construction plane in respective cross-sectional areas of the areas of the respective three-dimensional objects to be manufactured, by means of an energy beam generated by a beam generation device.

The application or coating properties of the construction material represent an essential criterion for the quality of the construction material layers to be formed by means of the coating device. The application or coating properties of the construction material are determined especially by physico-chemical interactions, i.e., for example, Van der Waals forces, hydrogen bonds resulting from moisture enrichment, etc., between the construction material particles. Previous approaches to optimize the application or coating properties of the construction material are based, among other things, on the relatively complex material-related influencing of the construction material, e.g., by choosing the particle morphology and/or particle composition.

The invention is based on the object to provide, in contrast to the above, especially with regard to improved application or coating properties of the construction material, an improved apparatus for additive manufacturing of a three-dimensional object.

The object is solved by an apparatus according to claim 1. The dependent claims relate to special embodiments of the apparatus. The object is furthermore solved by a method according to claim 16.

The apparatus described herein generally serves for additive or generative manufacturing of at least one three-dimensional object, i.e., typically a technical component or technical component group, by successive, selective layer-by-layer solidification of individual construction material layers of a particulate or powdered construction material which can be solidified by means of at least one energy beam generated by at least one beam generation device. The apparatus can especially be an apparatus for performing additive laser melting methods, an SLM apparatus in short. The successive, selective layer-by-layer solidification of the construction material layers to be solidified is performed based on construction data. The construction data generally describe the geometric or geometric structural design of the respective three-dimensional object to be additively manufactured (hereinafter, in short, referred to as “object”). The construction data can be, for example, CAD data of the object to be manufactured or created on the basis of such data.

The apparatus comprises the typical required functional components for performing additive construction processes, i.e., especially a beam generation device for the generation of an energy beam, especially a laser or electron beam, for selective solidification of respective construction material layers of a particulate construction material, especially metal powder, plastic powder, or ceramic powder, and coating device for forming construction material layers to be solidified in a construction plane. A construction plane can be a surface of a carrying element, typically supported movably (in vertical direction), of a carrying device or an already solidified construction material layer.

The carrying element or carrying device typically represents a bottom limitation of a powder chamber volume of a powder module. The powder module is provided for receiving and/or dispensing construction material. Every powder module comprises a powder chamber for receiving construction material to be selectively solidified within the scope of an additive construction process or construction material not solidified within the scope of an additive construction process. The powder chamber limits a powder chamber volume that can be filled with construction material. The powder chamber volume is limited at least on the sides by walls (powder chamber walls) of the powder chamber generally formed like a hollow cuboid or hollow cylinder. As mentioned, the powder chamber volume is limited at the bottom by the carrying device The powder module can be, for example, a construction module in which the actual additive construction of three-dimensional objects is performed and which is for this purpose filled with construction material to be solidified in a successive, selective layer-by-layer manner when performing additive manufacturing processes, a metering module via which construction material is metered out into a process chamber successively and in layers when performing additive manufacturing processes, or a collector module which is filled with construction material that is not solidified when performing additive manufacturing processes.

The apparatus furthermore comprises at least one fluidization device. The fluidization device is provided for at least sectional fluidization of the construction material that can be applied as a construction material layer to be selectively solidified or the construction material (already) applied as a construction material layer to be selectively solidified. Fluidization is understood to mean—similar to the fluidized bed technique—especially a (local or locally limited) agitation of the construction material or construction material particles, which gives the construction material fluid-like properties; therefore, the construction material or a respective construction material layer can at least sectionally be turned into a kind of fluidized bed. Agitation of the construction material has a positive effect on the application or coating properties and application or coating behavior respectively of the construction material—(largely) regardless of the material composition of the construction material. This is because the fluidization causes a neutralization or attenuation of the physico-chemical interactions of the construction material particles described in connection with the state of the art mentioned at the beginning, which is based especially on a modification of the contact points of the construction material particles resulting from the fluidization. Fluidization of the construction material can cause a (temporal) neutralization or attenuation of the gravitational forces impacting the construction material particles. Fluidization of the construction material is performed before (as regards time) the selective solidification of the construction material.

Consequently, especially with regard to improved application or coating properties of the construction material, an improved apparatus for additive manufacturing of a three-dimensional object is provided.

In a first embodiment, the fluidization device can be provided for generating a gas flow which causes at least sectional fluidization of the construction material that can be applied as a construction material layer to be selectively solidified and/or the construction material applied as a construction material layer to be selectively solidified. Fluidization of the construction material or construction material layer is here effected by a gas flow generated by the fluidization device. The gas flow can extend angularly, especially opposed to the effective direction of gravity, relative to the construction plane. The extension of the gas flow opposed to the effective direction of gravity can cause the mentioned (temporal) neutralization or attenuation of the gravitational forces impacting the construction material particles. With regard to its flow properties, i.e., especially the flow type, wherein an (as) laminar (as possible) gas flow is preferred, and flow rate, wherein an (as) low (as possible) flow rate is preferred, the gas flow is chosen such that it does not impair any already formed construction material layer. The agitation generated by the gas flow typically causes local or locally limited agitation of the construction material or construction material layer.

The gas flow is typically formed by an inert flow gas (inert gas) or inert flow gas mixture. Hence, there is no reactive interaction between the flow gas or flow gas mixture and the construction material. The flow gas can be argon or nitrogen, for example. The flow gas mixture can contain argon or nitrogen, for example.

The gas flow can be fed into the construction material via one or more, especially diffusor- or nozzle-like, flow opening(s) formed in a functional component of the coating device. The functional component is especially a blade-like or blade-shaped coating element (coater blade). The functional component can be coupled with a flow generation device via which the gas flow can be fed or dumped into the functional component. The flow openings can be arranged and aligned such that the gas flow is (largely) parallel to the construction plane at least regarding its main flow direction. If several flow openings are provided, these can be arranged in rows and/or columns, hence next to each other or on top of each other, optionally in groups. At least one flow opening can be formed with a geometry influencing, i.e., especially slackening and/or homogenizing, the flow properties, i.e., for example, a lattice-like or lattice-shaped diffusor or nozzle geometry.

To influence, i.e., especially slacken and/or homogenize, the flow properties of the gas flow, of course, also at least one separate diffusor element can be provided which is functionally assigned to at least one flow opening. The diffusor element can be connected upstream or downstream of the at least one flow opening.

In another embodiment the or at least one fluidization device can be provided for generating mechanical vibrations that cause at least sectional fluidization of the construction material that can be applied as a construction material layer to be selectively solidified and/or the construction material applied as a construction material layer to be selectively solidified. Fluidization of the construction material or construction material layer is here effected by mechanical vibrations generated by the fluidization device. With regard to their vibration properties, i.e., especially amplitude and frequency, the generated vibrations are chosen such that they do not impair any already formed construction material layer. The agitation generated by the mechanical vibrations typically causes a local or locally limited agitation of the construction material or construction material layer.

The mechanical vibrations can especially be acoustic vibrations, i.e., sound, especially ultrasound. The mechanical vibrations can be heterogeneous; for example, they can be periodic or aperiodic and linear or non-linear mechanical vibrations respectively. The properties, i.e., type, form, amplitude, frequency, etc., of the mechanical vibrations concretely used or to be used for fluidization of a construction material layer are to be defined especially dependent on various construction material parameters, i.e., especially the degree of compression, particle type (distribution), particle form (distribution), particle size (distribution), etc., of the construction material layer and/or process parameters. A mechanical vibration can be composed of several superimposed or combined individual vibrations, such that a vibration spectrum results from the superposition or combination of the individual vibrations.

The mechanical vibrations can be fed into the construction material via at least one vibration generation element arranged or formed on or in a functional component of the coating device. The mechanical vibrations for fluidization of the construction material or a construction material layer can therefore be fed into a construction material layer directly via a respective coating element. The vibration generation element or the functional component can be coupled with a vibration generation device via which respective vibrations can be fed into the vibration generation element or the functional component. The functional component in turn is especially a blade-like or blade-shaped coating element (coater blade). It is also imaginable that a vibration generation element is integrated into the coating element. The vibration generation element can be or comprise a piezoelectric element, i.e., generally an acousto-mechanical transducer element.

Apart from the fluidization device, which, as described, serves to improve the application or coating properties of the construction material, the apparatus can additionally comprise a vibration device which serves to solidify the construction material layer. The vibration device is provided respectively for feeding mechanical vibrations into at least some sections of a construction material layer for at least sectional solidification of the construction material layer. The mechanical vibrations fed into the construction material layer via the vibration device to be insofar also referred to or considered as solidification device result in at least sectional (possibly further) solidification of the construction material layer. Solidification of the construction material layer is based on an at least sectional mechanical excitation of the construction material by the mechanical vibrations fed into the construction material layer. This allows the filling of existing “vacancies” in the micro- or macrostructure of the construction material layer and thus causes a denser arrangement of construction material particles, which results in a comparably denser packing of the construction material layer or in a solidification of the structure of the construction material layer. The rearrangement or reorientation of construction material particles induced by the mechanical vibrations directly influences the micro- or macrostructure of the construction material layer. Mechanical vibrations in turn are understood to mean especially acoustic vibrations, i.e., sound. Solidification can take place simultaneously with or after fluidization.

The mechanical vibrations serving to solidify the construction material layer can be heterogeneous; for example, they can also be periodic or aperiodic and linear or non-linear mechanical vibrations respectively. The properties, i.e., type, form, amplitude, frequency, etc., of the mechanical vibrations concretely used or to be used for solidification of a construction material layer are also here to be defined especially dependent on various construction material parameters, i.e., especially the degree of compression, particle type (distribution), particle form (distribution), particle size (distribution), etc., of the construction material layer and/or process parameters. Of course, also in this case, a mechanical vibration can be composed of several superimposed or combined individual vibrations such that a vibration spectrum results from the superposition or combination of the individual vibrations. The frequency of the mechanical vibrations typically lies in a range between 10 Hz and 100 kHz, especially in a range between 50 Hz and 100 kHz. Of course, upward and/or downward exceptions are imaginable since the frequency, as an essential property of periodic mechanical vibrations, is to be defined dependent on various parameters such as the construction material layer. As a general rule, the mechanical vibrations for solidification of the construction material typically differ or may differ from the mechanical vibrations for fluidization of the construction material.

For the generation and transmission of mechanical vibrations, the vibration device typically comprises at least one vibration generation element for the generation of mechanical vibrations with at least one certain vibration characteristic or certain vibration properties and at least one vibration transmission element for the transmission of generated mechanical vibrations to or into a construction material layer or transmission medium. The mechanical vibrations can hence be generated via a vibration generation element associated with the vibration device, i.e., for example, a generator or transducer element, and transmitted via a downstream vibration transmission element, i.e., for example, a membrane element, into a construction material layer or transmission medium, i.e., for example, inert gas or air between the transmission element and the construction material layer. Concretely, a vibration generation element can, for example, be formed as or at least comprise an electromechanical, especially acoustic or piezoelectric, transducer element.

The vibration device or an associated vibration transmission element can contact at least sectionally a construction material layer to be solidified at least while mechanical vibrations are fed into the construction material layer, such that generated mechanical vibrations can be fed into the construction material layer directly via the vibration transmission element. Mechanical vibrations can hence be fed into a construction material layer purely mechanically.

Of course, it is also imaginable that the vibration device or an associated vibration transmission element does not contact a construction material layer at least while mechanical vibrations are fed into the construction material layer, such that generated mechanical vibrations can be fed into the construction material layer indirectly via a transmission medium, as mentioned, e.g., inert gas. Mechanical vibrations can hence (also) be fed into a construction material layer purely acoustically or contactless.

The vibration device or vibration transmission element can be coupled for movement with the coating device typically movably supported at least relative to a construction plane. The coupling for movement between the vibration device or vibration transmission element and the coating device can be realized such that it is arranged or formed on or in the coating device. Hereby, a very compact arrangement or integration of the vibration device or vibration transmission element in or into the apparatus is given. The movable support of the coating device can, for example, be realized with a guiding device, especially a linear guiding device, or by coupling the coating device with a guiding device, especially a linear guiding device, by means of which the coating device can be moved at least relative to the construction plane in a construction or process chamber of the apparatus for forming a construction material layer.

The vibration device can be arranged in or parallel to an, especially blade-shaped, coating element associated with the coating device. It is imaginable that an, especially blade-shaped, coating element associated with the coating device itself is formed or serves as a vibration transmission element. Mechanical vibrations for solidification of the construction material layer can hence be fed into a construction material layer directly via a respective coating element. For this purpose, the coating element is excited mechanically by respective mechanical vibrations. The mechanical vibrations are fed into the construction material layer via the respective excited coating element.

As an alternative to the arrangement or formation of the vibration device or a vibration generation element on or in the coating device, it is also imaginable that the vibration device, especially an associated vibration transmission element for the transmission of generated mechanical vibrations, is coupled for movement with a separate holding device which is movably supported in at least one freedom degree of motion, especially at least relative to a construction plane, i.e., especially arranged or formed on or in the holding device. The movably supported holding device can track the coating device while forming a respective construction material layer such that similar or identical movement paths, especially relative to a construction plane, result. The movable support of the holding device can, for example, be realized with a guiding device, especially a linear guiding device, or by coupling the holding device with a guiding device, especially a linear guiding device, by means of which the holding device can be moved in at least one freedom degree of motion, especially relative to a construction plane, in a construction or process chamber of the apparatus.

As an alternative to the arrangement or formation of the vibration device or a vibration generation element on or in the coating device or a respective holding device, it is also imaginable that the vibration device, especially an associated vibration transmission element for the transmission of generated mechanical vibrations, is arranged or formed on or in a powder module. Concretely, the vibration device or a vibration generation element can be arranged or formed in a powder chamber wall or carrying device.

In addition to the apparatus, the invention also relates to a method for additive manufacturing of a three-dimensional object by successive, selective layer-by-layer solidification of individual construction material layers of a particulate construction material that can be solidified by means of an energy beam generated by a beam generation device. The method is characterized in that the construction material that can be applied as a construction material layer to be selectively solidified and/or the construction material applied as a construction material layer to be selectively solidified is fluidized at least sectionally by means of a fluidization device. All embodiments in connection with the apparatus described above therefore apply analogously to the method.

The invention is explained in more detail by means of exemplary embodiments in the drawings. In which:

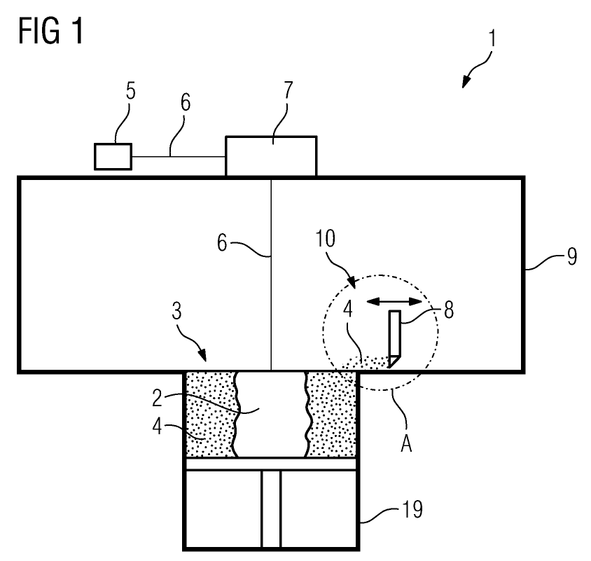

FIG. 1 shows a schematic diagram of an apparatus for additive manufacturing of a three-dimensional object according to an exemplary embodiment;

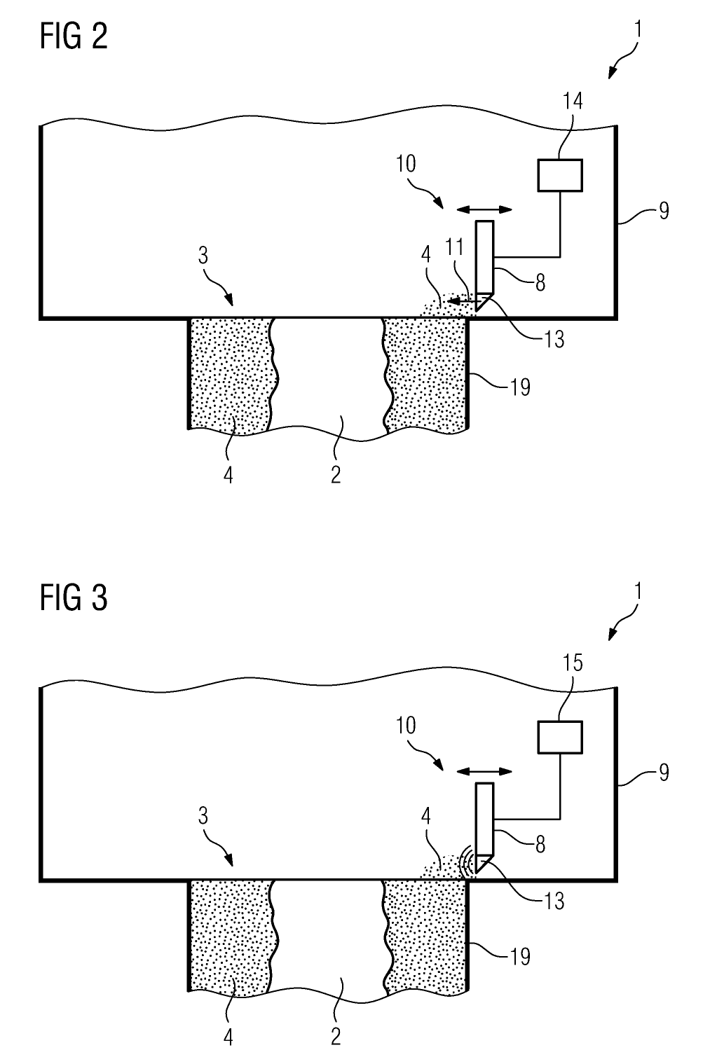

FIGS. 2-4 each show an enlarged schematic diagram of the individual unit A of the apparatus shown in FIG. 1 according to an exemplary embodiment; and

FIG. 5 shows a schematic diagram of the coating element according to the exemplary embodiment shown in FIG. 2.

FIG. 1 shows a schematic diagram of an apparatus 1 for additive manufacturing of three-dimensional objects 2 according to an exemplary embodiment. The apparatus 1 can be an SLM apparatus.

The apparatus 1 serves for additive manufacturing of a three-dimensional object 2, i.e., typically a technical component or technical component group, by selective solidification of construction material layers formed in a construction plane 3 of a particulate construction material 4 to be solidified by means of an energy or laser beam 6 generated by a beam generation device 5. Formation and successive, selective layer-by-layer solidification of the construction material layers is performed in a construction chamber 9 of the apparatus 1. In the construction chamber 9 there is typically an inert gas atmosphere, i.e., for example, an argon or nitrogen atmosphere.

The construction material 4 can be a metal powder (mixture) that can be solidified by means of a respective energy beam 6, i.e., for example, aluminum powder, and/or a plastic powder (mixture) that can be solidified by means of a respective energy beam 6, i.e., for example, polyetheretherketone powder, and/or a ceramic powder (mixture) that can be solidified by means of a respective energy beam 6, i.e., for example, aluminum oxide powder.

The selective layer-by-layer solidification of a construction material layer formed in the construction plane 3 to be solidified by means of an, as indicated by the horizontally oriented arrow, movably supported coating device 8 is performed such that the energy beam 6 generated by the beam generation device 5 is directed, possibly with a beam deflection device 7 or scanner device, selectively onto certain sections of the construction material layer to be solidified corresponding to respective layer-related cross-section geometries of the object 2 to be manufactured.

The apparatus 1 furthermore comprises at least one fluidization device 10. The fluidization device 10 is provided for at least sectional fluidization of the construction material 4 that can be applied as a construction material layer to be selectively solidified or the construction material 4 (already) applied as a construction material layer to be selectively solidified. Fluidization is understood to mean especially a (local or locally limited) agitation of the construction material 4 or construction material particles, which gives the construction material 4 fluid-like properties. Agitation of the construction material 4 has a positive effect on the application or coating properties and application or coating behavior respectively of the construction material 4. Fluidization of the construction material 4 can cause a (temporal) neutralization or attenuation of the gravitational forces impacting the construction material particles. Fluidization of the construction material 4 is performed before (as regards time) selective solidification of the construction material 4.

FIG. 2 shows an enlarged schematic diagram of the individual unit A of the apparatus 1 shown in FIG. 1 according to another exemplary embodiment. In the exemplary embodiment shown in FIG. 2, the fluidization device 10 is provided for generating a gas flow, indicated by the arrows 11, that causes at least sectional fluidization of the construction material 4. Fluidization of the construction material 4 is here effected by a gas flow generated by the fluidization device 10. The gas flow can extend angularly, especially opposed to the effective direction of gravity, relative to the construction plane. The extension of the gas flow opposed to the effective direction of gravity can cause a (temporal) neutralization or attenuation of the gravitational forces impacting the construction material particles. With regard to its flow properties, the gas flow is chosen such that it does not impair any already formed construction material layer. The agitation generated by the gas flow typically causes local or locally limited agitation of the construction material 4. The gas flow runs with an (as) laminar (as possible) gas flow and an (as) low (as possible) flow rate.

The gas flow is formed by an inert flow gas (inert gas) or inert flow gas mixture. There is no reactive interaction between the flow gas or flow gas mixture and the construction material 4. The flow gas can be argon or nitrogen, for example. The flow gas mixture can contain argon or nitrogen, for example.

The gas flow can be fed into the construction material 4 via one or more, especially diffusor- or nozzle-type, flow opening(s) 12, cf. FIG. 5, formed in a functional component of the coating device 8. The functional component is a blade-like or blade-shaped coating element 13 (coater blade). The coating device 8 or coating element 13 is coupled with a flow generation device 14 via which the gas flow can be fed or dumped into the coating device 8 or coating element 13.

From FIG. 5, which shows a frontal view of the coating element 13, it can be seen that the flow openings 12 are arranged and aligned such that the gas flow flows (largely) parallel to the construction plane 3 at least regarding its main flow direction. From FIG. 5 it can also been seen that, if several flow openings 12 are provided, these can be arranged in rows, hence next to each other. At least one flow opening 12 can be formed with a geometry influencing, i.e., especially slackening and/or homogenizing, the flow properties, i.e., for example, a lattice-like or lattice-shaped diffusor or nozzle geometry.

To influence, i.e., especially slacken and/or homogenize, the flow properties of the gas flow, at least one separate diffusor element (not shown) can be provided which is functionally assigned to at least one flow opening 12.

FIG. 3 shows an enlarged schematic diagram of the individual unit A of the apparatus 1 shown in FIG. 1 according to another exemplary embodiment. In the exemplary embodiment shown in FIG. 3, the fluidization device 10 is provided for generating mechanical vibrations that cause at least sectional fluidization of the construction material 4. Fluidization of the construction material 4 is here effected by mechanical vibrations generated by the fluidization device 10. With regard to their vibration properties, i.e., especially amplitude and frequency, the generated vibrations are chosen such that they do not impair any already formed construction material layer. The agitation generated by the mechanical vibrations typically causes a local or locally limited agitation of the construction material 4.

The mechanical vibrations are acoustic vibrations, i.e., sound, especially ultrasound. The mechanical vibrations can be fed into the construction material 4 via the coating element 13. Therefore, the mechanical vibrations for fluidization of the construction material 4 are fed into a construction material layer directly via the coating element 13. For this purpose, the coating element 13 is coupled with a vibration generation device 16, via which respective vibrations can be fed into the coating element 13.

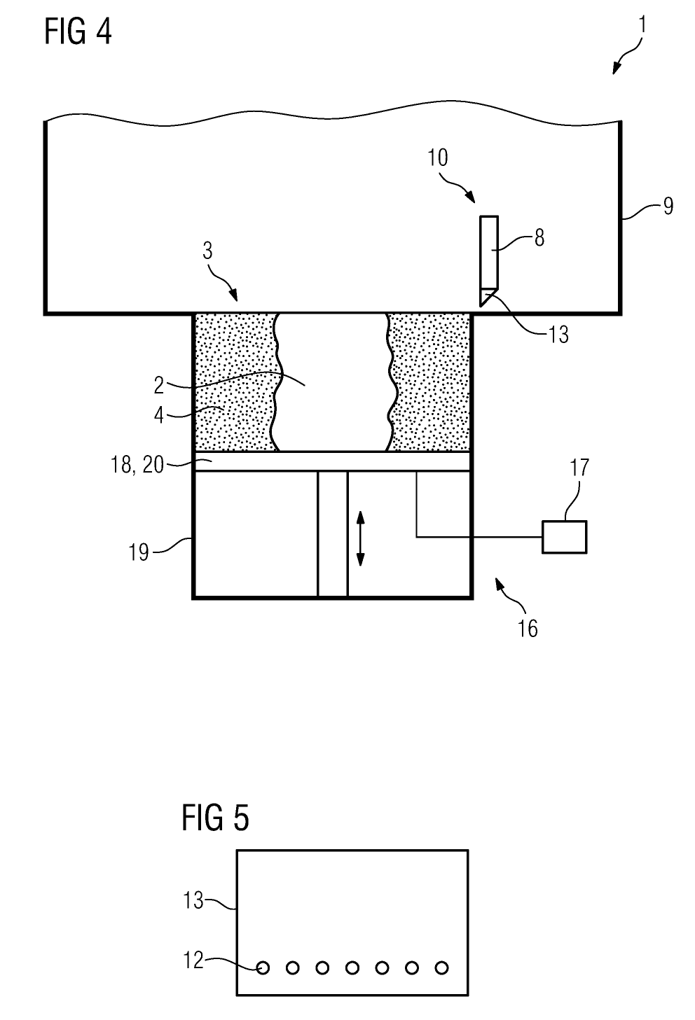

FIG. 4 shows an enlarged schematic diagram of the individual unit A of the apparatus 1 shown in FIG. 1 according to another exemplary embodiment. The exemplary embodiment shown in FIG. 4 shows in addition to the fluidization device 10 a vibration device 16 which serves to solidify the construction material layer. The vibration device 16 is provided for feeding mechanical vibrations into at least some sections of a construction material layer for at least sectional solidification of the construction material layer. The mechanical vibrations fed into the construction material layer via the vibration device to be insofar also referred to or considered as solidification device result in at least sectional (possibly further) solidification of the construction material layer.

For the generation and transmission of mechanical vibrations, the vibration device comprises a vibration generation element 17 for the generation of mechanical vibrations with at least one certain vibration characteristic or certain vibration properties and a vibration transmission element 18 for the transmission of generated mechanical vibrations to or into a construction material layer. The vibration generation element 17 is provided for generating sound or ultrasound.

The vibration transmission element 18 is the carrying device 20 representing a bottom limitation of the powder chamber volume of the powder or construction module 19.

By means of the apparatus 1 shown in the Fig., a method for additive manufacturing of a three-dimensional object 2 by selective solidification of individual construction material layers of a particulate construction material 4 that can be solidified by means of an energy beam 6 generated by a beam generation device 5 can be implemented. The method, which can especially be an SLM method, is especially characterized in that the construction material 4 is fluidized at least sectionally by means of a fluidization device 10.

1. An apparatus (1) for additive manufacturing of at least one three-dimensional object (2) by successive selective solidification of individual construction material layers (3) of a particulate construction material (4) that can be solidified by means of an energy beam (6) generated by a beam generation device (5), comprising
at least one beam generation device (5) for the generation of an energy beam (6) and
at least one coating device (9) for forming a construction material layer to be solidified in a construction plane (3),
characterized by at least one fluidization device (10) provided for at least sectional fluidization of the construction material (4) that can be applied as a construction material layer to be selectively solidified and/or the construction material (4) applied as a construction material layer to be selectively solidified.

2. An apparatus according to claim 1, characterized in that the at least one fluidization device (10) is provided for generating a gas flow which causes at least sectional fluidization of the construction material (4) that can be applied as a construction material layer to be selectively solidified and/or the construction material (4) applied as a construction material layer to be selectively solidified.

3. An apparatus according to claim 2, characterized in that the gas flow extends angularly, especially opposed to the effective direction of gravity, relative to the construction plane (3).

4. An apparatus according to claim 2, characterized in that the gas flow is formed by an inert flow gas, especially argon or nitrogen, or an inert flow gas mixture.

5. An apparatus according to claim 3, characterized in that the gas flow can be fed into the construction material (4) via at least one, especially diffusor- or nozzle-like, flow opening (12) formed in a functional component of the coating device (8), especially in a blade-like coating element (13).

6. An apparatus according to claim 5, characterized in that the at least one flow opening (12) is assigned at least one separate diffusor element provided for generating a laminar gas flow.

7. An apparatus according to claim 1, characterized in that the at least one fluidization device (10) is provided for generating mechanical vibrations which cause at least sectional fluidization of the construction material (4) that can be applied as a construction material layer to be selectively solidified and/or the construction material (4) applied as a construction material layer to be selectively solidified.

8. An apparatus according to claim 7, characterized in that the mechanical vibrations can be fed into the construction material (4) via at least one, especially piezoelectric, vibration generation element arranged or formed on or in a functional component of the coating device (8), especially on or in a blade-like coating element (13).

9. An apparatus according to claim 1, characterized by at least one vibration device (16) provided for feeding mechanical vibrations into at least some sections of a construction material layer to be selectively solidified for at least sectional solidification of the construction material layer.

10. An apparatus according to claim 9, characterized in that the vibration device (10) comprises at least one vibration generation element (17) for the generation of mechanical vibrations with a certain vibration characteristic and at least one vibration transmission element (18) for the transmission of generated mechanical vibrations to a construction material layer or transmission medium.

11. An apparatus according to claim 10, characterized in that at least one vibration transmission element (18) contacts at least sectionally the construction material layer at least while mechanical vibrations are fed into the construction material layer, such that generated mechanical vibrations can be fed into the construction material layer directly via the vibration transmission element (18).

12. An apparatus according to claim 10, characterized in that at least one vibration transmission element (18) does not contact the construction material layer at least while mechanical vibrations are fed into the construction material layer, such that generated mechanical vibrations can be fed into the construction material layer indirectly via a transmission medium.

13. An apparatus according to one of the claim 10, characterized in that the vibration device (16), especially an associated vibration transmission element (18) for the transmission of generated mechanical vibrations, is movably supported in at least one freedom degree of motion, wherein the vibration device (16) is coupled for movement with the coating device (8) which is movably supported at least relative to a construction plane (3), especially arranged or formed on or in the coating device (8), or is coupled for movement with a movably supported carrying device (20), especially arranged or formed on or in the carrying device (20).

14. An apparatus according to claim 13, characterized in that the vibration device (16), especially an associated vibration transmission element (18) for the transmission of generated mechanical vibrations, is movably supported in at least one freedom degree of motion, wherein the vibration device (16) is coupled for movement with a holding device which is movably supported in at least one freedom degree of motion, especially at least relative to a construction plane, especially arranged or formed on or in the holding device.

15. An apparatus according to claim 12, characterized in that the vibration device (16), especially an associated vibration transmission element (18) for the transmission of generated mechanical vibrations, is not movably supported, wherein the vibration device (10) is arranged or formed on a not movably supported holding device or on a wall of a powder module (19) limiting a powder chamber wall.

16. A method for additive manufacturing of a three-dimensional object (2) by successive selective solidification of individual construction material layers of particulate construction material (4) that can be solidified by means of an energy beam (6) generated by a beam generation device (5) in a construction plane (3),
characterized in that the construction material (4) that can be applied as a construction material layer to be selectively solidified and/or the construction material (4) applied as a construction material layer to be selectively solidified is fluidized at least sectionally by means of a fluidization device (10).
